(19) United States
(12) Patent Application Publication
(10) Pub. No.: US 2006/0288904 A1
(43) Pub. Date: Dec. 28, 2006

(54) Micronized wood preservative compositions

(76) Inventors: Robert M. Leach, Grand Island, NY (US); Jun Zhang, Getzville, NY (US)

Correspondence Address: HODGSON RUSS LLP, ONE M & T PLAZA, SUITE 2000, BUFFALO, NY, 14203-2391, US

(21) Appl. No.: 11/471,763

(22) Filed: Jun. 21, 2006

Related U.S. Application Data
(60) Provisional application No. 60/692,491, filed on Jun. 21, 2005.

(51) Int. Cl. C09D 5/14; C09D 5/16; B05D 3/00; A01N 43/82; A01N 43/64; B05D 1/02; B05D 1/28; B05D 1/18; A01N 59/20

(52) U.S. Cl. 106/15.05; 106/18.32; 424/630; 424/633; 424/634; 424/635; 427/297; 427/421.1; 427/429; 427/440; 514/360; 514/383

(57) ABSTRACT

Provided is a preservation composition having a large-particle distribution which can effectively penetrate and preserve wood. The composition comprises a particulate dispersion of biocidal particles such that at least about 3 weight percent of the particles have diameters are greater than about 0.5 micron, and at least 98 wt % of the particles have diameters of less than about 10 microns. Also provided is a method for preserving wood with the composition.

This application claims priority to U.S. provisional application No. 60/692,491, filed on Jun. 21, 2005, the disclosure of which is incorporated herein by reference.

### FIELD OF THE INVENTION

The present invention is related generally to the field of wood preservatives and more particularly to a wood preservative composition comprising micronized particles.

### BACKGROUND OF THE INVENTION

Wood preserving compositions are used for preserving wood and other wood-based materials, such as paper, particleboard, wood composites, plastic lumbers, rope, etc., against organisms which destroy wood. Many conventional wood preserving compositions contain copper amine complexes. Copper amine complexes have been used in the past because the amine solubilizes the copper in aqueous solutions. The copper in such copper amine complexes is obtained from a variety of copper bearing materials, such as copper scrap, cuprous oxide, copper carbonate, copper hydroxide, a variety of cuprous and cupric salts, and copper bearing ores. The amine in such copper amine complexes is normally obtained from an aqueous solution of ammonia and ammonium salts, such as ammonium carbonate, and ammonium sulfate, ethanolamines, et cetera. For example, U.S. Pat. No. 4,622,248 describes forming copper amine complexes by dissolving copper(II)oxide [CuO] (also known as cupric oxide) in ammonia in the presence of ammonium bicarbonate.

However, copper ammonia preservatives can affect the appearance of the treated wood giving surface residues and undesirable color. Furthermore, the high ammonia content gives copper ammonia preservatives a strong odor. In recent years, many amine-containing compounds, such as the ethanolamines and aliphatic polyamines, have been used to replace ammonia to formulate water-soluble copper solutions. These compounds were chosen because of their strong complexing ability with copper and because they are essentially odorless. U.S. Pat. No. 4,622,248 discloses a method of preparing copper amine complexes by dissolving a mixture of copper(II)carbonate [CuCO₃] and copper(II)hydroxide [Cu(OH)₂] in ethanolamine and water. The complexing amine (i.e., the ligand) and copper(II)ion combine stoichiometrically and thus the weight ratio of reagents will be different for each complexing amine. However, copper amine based preservatives have higher copper loss due to leaching as compared to traditional copper based preservatives such as chromated copper arsenate (CCA).

Many wood preservative compositions contain organic biocides, many of which, like copper compounds, have low water solubilities. Solubilizing agents or surfactants such as emulsifying agents, wetting agents, etc. are added in order to give a product that is suitable for the treatment of wood or other cellulose substrates. However, solubilizing agents or surfactants, etc. are costly and, as with copper compound biocides, the use of these products may also result in enhanced leaching of organic biocide upon exposure of treated wood to moisture.

It is generally thought that the enhanced leaching of copper biocides is due to the fact that solubilizing agents, surfactants, emulsifying agents, wetting agents, etc. remain in the wood after treatment. Upon exposure to moisture, the biocides are solubilized, and they wash out of the wood. Excessive leaching of copper-based biocides from the treated wood or other cellulose substrates can result in field performance problems or environmental issues.

There continues to be a need in the area of wood preservation for compositions which exhibit improved penetration but minimal leaching.

### SUMMARY OF THE INVENTION

The present invention provides micronized compositions for preservation of wood and wood products. The compositions are particularly effective in the preservation of permeable woods, including, for example, woods of the southern pine group, red pine, ponderosa pine, Brazilian pine, Caribbean pine, patula pine, radiata pine and the like.

The wood preservative compositions comprise metals, metal compounds, organic biocides, or a combination thereof. At least one of the metals, metal compounds and organic biocides comprise micronized particles, i.e., particles having a size in the range of from 0.001 and 25 microns. It has been surprisingly observed that it is unnecessary, contrary to teachings in the art, to prepare particles as distributions in which the vast majority of the particles has a size smaller than 0.5 microns, in order to obtain complete penetration of the wood. Rather, particles in size distributions as described herein are easy to prepare and are useful for the preservation of wood, particularly by particle impregnation. Such particle distributions are particularly effective for the preservation of pine and other coniferous woods. Accordingly, in the compositions of the present invention, at least 98 wt % of the particles (by weight) have a diameter less than 10 microns and at least 3 wt % of the particles have a diameter of 0.5 microns or greater.

The present invention also provides a method for treating wood comprising the steps of providing a mixture comprising micronized biocide particles in an aqueous carrier such that the particles are in the form of a dispersion, and applying the dispersion to a wood or wood product, such that at least 10 weight percent of the particles penetrate at least 1 mm into the wood. The particle size distributions in the compositions of the present invention are such that optimal penetration and minimal leaching can be achieved in the wood through commonly used pressure application methods.

The use of larger particles has the advantage that the treatment particle distributions containing larger particles are generally easier to prepare than distributions containing smaller particles. Furthermore, it is generally thought that that smaller particles may not protect against UV light to the same degree as larger particles.

In one embodiment, the compositions comprise micronized metal, metal compounds or organic biocides, or combinations thereof. If the composition comprises both organic compounds and metal/metal compounds, the organic biocides may be soluble or insoluble (i.e., micronized).

An advantage of the present invention is that no ammonia and alkanolamine is used in the preparation of the particles, enabling the preparation of a preserved wood or wood product which is substantially ammonia- and alkanolamine-free.

An example of a preferred metal for wood preserving compositions is copper in the form of elemental copper or a copper compound.

### BRIEF DESCRIPTION OF THE FIGURES

FIG. 1 depicts the anatomy of coniferous wood.

FIG. 2 depicts the border pit structure for coniferous wood.

FIG. 3A depicts the uniform copper penetration in wood treated with micronized copper hydroxide according to AWPA Standard A3-00 “Standard Method for Determining Penetration of Preservatives and Fire Retardants”.

FIG. 3B depicts the uniform copper penetration in wood treated with micronized copper carbonate plus quat. The determination of copper penetration was conducted following the procedures described in AWPA Standard A3-00 “Standard Method for Determining Penetration of Preservatives and Fire Retardants”.

FIG. 4 depicts the uniform particle distribution of copper carbonate through the cells of the wood treated with micronized copper carbonate.

FIGS. 5A and 5B depict a particle size distribution suitable for use in a wood preserving composition which was obtained by methods described herein. Approximately 12 wt % of the particles are over 0.5 microns.

FIGS. 6A and 6B depict a particle size distribution suitable for use in a wood preserving composition which were obtained by methods described herein. Approximately 16 wt % of the particles are over 0.5 microns.

FIGS. 7A and 7B depict a particle size distribution suitable for use in a wood preserving composition which were obtained by methods described herein. Approximately 25 wt % of the particles are over 0.5 microns.

FIGS. 8A and 8B depict a particle size distribution suitable for use in a wood preserving composition which were obtained by methods described herein. Approximately 43 wt % of the particles are over 0.5 microns.

FIGS. 9A and 9B depict a particle size distribution suitable for use in a wood preserving composition which were obtained by methods described herein. Approximately 13 wt % of the particles are over 0.5 microns.

### DETAILED DESCRIPTION OF THE INVENTION

The term “micronized” as used herein means a particle size in the range of 0.001 to 25 microns. The term “particle size” refers to the largest axis of the particle, and in the case of a generally spherical particle, the largest axis is the diameter.

The wood preservative compositions of the present invention comprise a particulate component. The particulate component can comprise metals, metal compounds, organic compounds, or combinations thereof. One or more of the metals, metal compounds, organic compounds, are present in the composition as micronized particles. In one embodiment of the present invention, the composition comprises both a metal/metal compound component and an organic biocide component, both of which are present as micronized particles.

The compositions of the present invention are used for treatment of cellulosic material, including wood and wood products such as composite wood products particularly, easy-to-treat species, such as wood species within southern pine group, red pine, ponderosa pine, Brazilian pine, Caribbean pine, Radiata pine, etc. Hereafter, the term “wood” is understood to mean cellulosic materials and wood products, including composite wood products. The leaching of metal from the treated wood is expected to be less for the present compositions than that observed from wood treated with non-micronized compositions.

A preferred metal is copper. Accordingly, in one embodiment, copper or copper compounds are used. The copper compounds which can be used include cuprous oxide, cupric oxide, copper hydroxide, copper carbonate, basic copper carbonate, copper oxychloride, copper 8-hydroxyquinolate, copper dimethyldithiocarbamate, copper omadine, copper borate, copper residues (copper metal byproducts) or any suitable copper source can be used as particles. These compounds exhibit a relatively low solubility in water.

It should be noted that the present invention is not limited to water-borne compositions, as it is expected that particles of the size distributions described herein which are carried in organic carriers, such as oils, will effectively penetrate wood as well. Preferred are compounds which have a Ksp in the chosen carrier of ≦2.5×10⁻² for ionic compounds, or a solubility ≦1.0% by weight in the chosen carrier for other compounds at room temperature.

The micronized particles can be obtained by grinding copper compounds using a commercially available grinding mill. Particulate compound can be wet or dry dispersed in a liquid prior to grinding. Other means of obtaining micronized particles include chemical or physical or mechanical means.

A preferred method is by grinding. One exemplary method involves the formation of a slurry comprising a dispersant, a carrier, and a powdered biocide having a particle size in the range of from 1 micron to 500 microns, and optionally, a defoamer. The slurry is transferred to a grinding mill which is prefilled with a grinding media having a size from 0.05 mm to 5 mm, and preferably between 0.1 and 1 mm. The media can be one or more of many commercially available types, including but not limited to steel shots, carbon steel shots, stannous steel shots, chrome steel shots, ceramic (for example, alumina-containing); zirconium-based, such as zirconia, zirconium silicate, zirconium oxide; stabilized zirconia such as stabilized ytz-stabilized zirconia, ceria-stabilized zirconia, stabilized magnesium oxide, stabilized aluminum oxide, etc. The medium preferably occupies 50% to 99% of the grinding chamber volume, with 75 to 95% preferred, and 80 to 90% more preferred. The bulk density of the grinding media is preferably in the range of from 0.5 kg/l to 10 kg/l, and more preferably in the range of from 2 to 5 kg/I. Agitation speed, which can vary with the size of the grinder, is generally in the range of from 1 to 5000 rpm, but can be higher or lower. Lab and commercial grinders generally run at different speeds. A set up which involves a transfer pump which repeatedly cycles the slurry between the mill and a storage tank during grinding is convenient. The transfer pump speed varies from 1 to 500 rpm, and the speeds for lab and commercial grinders can be different. During grinding, defoamer can be added if foaming is observed. During grinding, particle size distribution can be analyzed, and once particle size is within the desired specification, grinding is stopped.

In the compositions of the present invention, at least 98 wt % of the particles have a diameter less than 10 microns and at least 3 wt %, and in different embodiments, 3 to 50 wt %, 3 to 25 wt %, 3 to 10 wt %, and 3 to 5 wt % of the particles have a diameter of 0.5 microns or greater.

The composition of the present invention may additionally comprise non-biocidal components to further enhance the performance of the micronized organic biocide formulation or the appearance and performance of the resulting treated wood products. Non-limiting examples of such non-biocidal components are water repellants (for example, wax emulsions), colorants, emulsifying agents, dispersants, stabilizers, UV inhibitors, wood dimensional stabilizers,

For example, the micronized biocidal composition of the present invention can be prepared with a commercially available rheological additive such as a cellulosic derivative such that the micronized particles are finely dispersed. Those skilled in the art will recognize that some agents, while included in the composition primarily for reasons other than biocidal ability, may also have biocidal properties.

The composition can also comprise a defoamer, such as a Si-containing or a non-Si containing defoamer. The level of the defoamer, if included in the composition, is generally up to about 10 wt % based upon the weight of the composition, such as, for example, in the range of from 0.01 to 10 wt

The present invention is not limited to copper compounds. Other metals or metal compounds as well as transition metals or transition metal compounds (including the lanthanide and actinide series elements) such as tin, zinc, cadmium, silver, nickel, etc. and compounds thereof can be used instead of or in addition to copper or copper compounds.

As mentioned above, the compositions of the present invention can include additional biocides. For example, the composition can comprise organic biocides, water soluble as well as water insoluble. Additional organic biocides can include, for example, fungicides, insecticides, moldicides, bactericides, and algaecides. Chemical classes of organic biocides include azoles, quaternary ammonium compounds, borate compounds, fluoride compounds and combinations thereof.

Some non-limiting examples of water soluble biocides which can be used are quaternary ammonium compounds, such as, for example, alkyldimethylbenzylammonium chloride, dimethyldidecylammonium chloride, dimethyldidecylammonium carbonate/bicarbonate.

Some non-limiting examples of water insoluble organic biocides are shown below. Preferred fungicides which can be mixed with micronized metal formulations are:

Aliphatic Nitrogen Fungicides

butylamine; cymoxanil; dodicin; dodine; guazatine; iminoctadine

Amide Fungicides

carpropamid; chloraniformethan; cyazofamid; cyflufenamid; diclocymet; ethaboxam; fenoxanil; flumetover; furametpyr; prochloraz; quinazamid; silthiofam; triforine benalaxyl; benalaxyl-M; furalaxyl; metalaxyl; metalaxyl-M; pefurazoate; benzohydroxamic acid; tioxymid; trichlamide; zarilamid; zoxamide

cyclafuramid; furmecyclox dichlofluanid; tolylfluanid benthiavalicarb; iprovalicarb benalaxyl; benalaxyl-M; boscalid; carboxin; fenhexamid; metalaxyl; metalaxyl-M metsulfovax; ofurace; oxadixyl; oxycarboxin; pyracarbolid; thifluzamide; tiadinil benodanil; flutolanil; mebenil; mepronil; salicylanilide; tecloftalam

fenfuram; furalaxyl; furcarbanil; methfuroxam flusulfamide

Antibiotic Fungicides

aureofungin; blasticidin-S;

cycloheximide; griseofulvin; kasugamycin; natamycin; polyoxins; polyoxorim; streptomycin; vali damycin azoxystrobin dimoxystrobin fluoxastrobin kresoxim-methyl metominostrobin orysastrobin picoxystrobin pyraclostrobin trifloxystrobin

Aromatic Fungicides

biphenyl chlorodinitronaphthalene chloroneb chlorothalonil cresol dicloran hexachlorobenzene pentachlorophenol quintozene sodium pentachlorophenoxide tecnazene

Benzimidazole Fungicides

benomyl carbendazim chlorfenazole cypendazole debacarb fuberidazole mecarbinzid rabenzazole thiabendazole

Benzimidazole Precursor Fungicides

furophanate thiophanate thiophanate-methyl

Benzothiazole Fungicides

bentaluron chlobenthiazone TCMTB

Bridged Diphenyl Fungicides

bithionol dichlorophen diphenylamine

Carbamate Fungicides

benthiavalicarb furophanate iprovalicarb propamocarb thiophanate thiophanate-methyl benomyl carbendazim cypendazole debacarb mecarbinzid

diethofencarb

Conazole Fungicides

climbazole clotrimazole imazalil oxpoconazole prochloraz triflumizole azaconazole bromuconazole cyproconazole diclobutrazol difenoconazole diniconazole diniconazole-M epoxiconazole etaconazole fenbuconazole fluquinconazole flusilazole flutriafol furconazole furconazole-cis hexaconazole imibenconazole ipconazole metconazole myclobutanil penconazole propiconazole prothioconazole quinconazole simeconazole tebuconazole tetraconazole triadimefon triadimenol triticonazole uniconazole uniconazole-P

Dicarboximide Fungicides

famoxadone fluoroimide chlozolinate dichlozoline iprodione isovaledione myclozolin procymidone vinclozolin captafol captan ditalimfos folpet thiochlorfenphim

Dinitrophenol Fungicides

binapacryl dinobuton dinocap dinocap-4 dinocap-6 dinocton dinopenton dinosulfon dinoterbon DNOC

Dithiocarbamate Fungicides

azithiram carbamorph cufraneb cuprobam disulfiram ferbam metam nabam tecoram thiram ziram dazomet etem milneb mancopper mancozeb maneb metiram polycarbamate propineb zineb

Imidazole Fungicides

cyazofamid fenamidone fenapanil glyodin iprodione isovaledione pefurazoate triazoxide

Morpholine Fungicides

aldimorph benzamorf carbamorph dimethomorph dodemorph fenpropimorph flumorph tridemorph

Organophosphorus Fungicides

ampropylfos ditalimfos edifenphos fosetyl hexylthiofos iprobenfos phosdiphen pyrazophos tolclofos-methyl triamiphos

Oxathiin Fungicides

carboxin oxycarboxin

Oxazole Fungicides

chlozolinate dichlozoline drazoxolon famoxadone hymexazol metazoxolon myclozolin oxadixyl vinclozolin

Pyridine Fungicides

boscalid buthiobate dipyrithione fluazinam pyridinitril pyrifenox pyroxychlor pyroxyfur

Pyrimidine Fungicides

bupirimate cyprodinil diflumetorim dimethirimol ethirimol fenarimol ferimzone mepanipyrim nuarimol pyrimethanil triarimol

Pyrrole Fungicides

fenpiclonil fludioxonil fluoroimide

Quinoline Fungicides

ethoxyquin halacrinate 8-hydroxyquinoline sulfate quinacetol quinoxyfen

Quinone Fungicides

benquinox chloranil dichlone dithianon

Quinoxaline Fungicides

chinomethionat chlorquinox thioquinox

Thiazole Fungicides

ethaboxam etridiazole metsulfovax octhilinone thiabendazole thiadifluor thifluzamide

Thiocarbamate Fungicides

methasulfocarb prothiocarb

Thiophene Fungicides

ethaboxam silthiofam

Triazine Fungicides

anilazine

Triazole Fungicides

bitertanol fluotrimazole triazbutil

Urea Fungicides

bentaluron pencycuron quinazamid

Other Fungicides

acibenzolar acypetacs allyl alcohol benzalkonium chloride benzamacril bethoxazin carvone chloropicrin DBCP dehydroacetic acid diclomezine diethyl pyrocarbonate fenaminosulf fenitropan fenpropidin formaldehyde furfural hexachlorobutadiene iodomethane isoprothiolane methyl bromide methyl isothiocyanate metrafenone nitrostyrene nitrothal-isopropyl OCH 2 phenylphenol phthalide piperalin probenazole proquinazid pyroquilon sodium orthophenylphenoxide spiroxamine sultropen thicyofen tricyclazole

Preferred insecticides which can be mixed micronized metal formulations are:

Antibiotic Insecticides

allosamidin thuringiensin spinosad abamectin doramectin emamectin eprinomectin ivermectin selamectin milbemectin milbemycin oxime moxidectin

Botanical Insecticides

anabasine azadirachtin d-limonene nicotine pyrethrins cinerins cinerin I cinerin II jasmolin I jasmolin II pyrethrin I pyrethrin II quassia rotenone

ryania sabadilla

Carbamate Insecticides

bendiocarb carbaryl benfuracarb carbofuran carbosulfan decarbofuran furathiocarb dimetan dimetilan hyquincarb pirimicarb alanycarb aldicarb aldoxycarb butocarboxim butoxycarboxim methomyl nitrilacarb oxamyl tazimcarb thiocarboxime thiodicarb thiofanox allyxycarb aminocarb

bufencarb butacarb carbanolate cloethocarb dicresyl

dioxacarb EMPC ethiofencarb fenethacarb fenobucarb isoprocarb methiocarb metolcarb mexacarbate promacyl promecarb propoxur

trimethacarb XMC xylylcarb

Dinitrophenol Insecticides

dinex dinoprop dinosam DNOC cryolite

sodium hexafluorosilicate sulfluramid

Formamidine Insecticides

amitraz chlordimeform formetanate formparanate

Fumigant Insecticides

acrylonitrile carbon disulfide carbon tetrachloride chloroform

chloropicrin para-dichlorobenzene 1,2-dichloropropane

ethyl formate ethylene dibromide ethylene dichloride ethylene oxide

hydrogen cyanide iodomethane methyl bromide methylchloroform

methylene chloride naphthalene phosphine sulfuryl fluoride

tetrachloroethane

Insect Growth Regulators

bistrifluron buprofezin chlorfluazuron cyromazine diflubenzuron flucycloxuron flufenoxuron hexaflumuron lufenuron novaluron noviflumuron penfluron teflubenzuron triflumuron

epofenonane fenoxycarb hydroprene kinoprene methoprene

pyriproxyfen triprene

juvenile hormone I

juvenile hormone II

juvenile hormone III

chromafenozide halofenozide methoxyfenozide tebufenozide

α-ecdysone ecdysterone diofenolan

precocene I

precocene II

precocene III

dicyclanil

Nereistoxin Analogue Insecticides

bensultap cartap thiocyclam thiosultap

flonicamid clothianidin dinotefuran imidacloprid thiamethoxam nitenpyram nithiazine

acetamiprid imidacloprid nitenpyram thiacloprid

Organochlorine Insecticides

bromo-DDT camphechlor DDT

pp′-DDT ethyl-DDD HCH gamma-HCH lindane

methoxychlor pentachlorophenol TDE

aldrin bromocyclen chlorbicyclen chlordane chlordecone dieldrin dilor endosulfan endrin HEOD heptachlor HHDN isobenzan

isodrin kelevan mirex

Organophosphorus Insecticides

bromfenvinfos chlorfenvinphos crotoxyphos dichlorvos dicrotophos dimethylvinphos fospirate heptenophos methocrotophos mevinphos monocrotophos naled naftalofos phosphamidon propaphos

schradan TEPP tetrachlorvinphos

dioxabenzofos fosmethilan phenthoate

acethion amiton cadusafos chlorethoxyfos chlormephos demephion

demephion-O

demephion-S demeton

demeton-O

demeton-S demeton-methyl

demeton-O-methyl

demeton-S-methyl demeton-S-methylsulphon

disulfoton ethion ethoprophos IPSP isothioate malathion methacrifos oxydemeton-methyl oxydeprofos oxydisulfoton phorate sulfotep

terbufos thiometon amidithion cyanthoate dimethoate ethoate-methyl formothion mecarbam omethoate prothoate sophamide vamidothion chlorphoxim phoxim phoxim-methyl azamethiphos coumaphos coumithoate dioxathion endothion menazon morphothion phosalone pyraclofos pyridaphenthion quinothion dithicrofos thicrofos azinphos-ethyl azinphos-methyl dialifos phosmet isoxathion zolaprofos chlorprazophos pyrazophos

chlorpyrifos chlorpyrifos-methyl butathiofos diazinon etrimfos lirimfos pirimiphos-ethyl pirimiphos-methyl primidophos pyrimitate tebupirimfos quinalphos quinalphos-methyl athidathion lythidathion methidathion prothidathion isazofos triazophos azothoate bromophos bromophos-ethyl carbophenothion chlorthiophos cyanophos cythioate dicapthon dichlofenthion etaphos famphur fenchlorphos fenitrothion fensulfothion fenthion fenthion-ethyl heterophos jodfenphos mesulfenfos parathion parathion-methyl phenkapton phosnichlor profenofos prothiofos sulprofos temephos

trichlormetaphos-3 trifenofos butonate trichlorfon mecarphon

fonofos trichloronat cyanofenphos EPN leptophos

crufomate fenamiphos fosthietan mephosfolan phosfolan pirimetaphos

acephate isocarbophos isofenphos methamidophos propetamphos

dimefox mazidox mipafox

Oxadiazine Insecticides

indoxacarb

Phthalimide Insecticides

dialifos phosmet tetramethrin

Pyrazole Insecticides

acetoprole ethiprole fipronil tebufenpyrad tolfenpyrad vaniliprole

Pyrethroid Insecticides

acrinathrin allethrin bioallethrin barthrin bifenthrin bioethanomethrin

cyclethrin cycloprothrin cyfluthrin beta-cyfluthrin cyhalothrin gamma-cyhalothrin lambda-cyhalothrin cypermethrin alpha-cypermethrin beta-cypermethrin theta-cypermethrin zeta-cypermethrin cyphenothrin

deltamethrin dimefluthrin dimethrin empenthrin fenfluthrin fenpirithrin fenpropathrin fenvalerate esfenvalerate flucythrinate fluvalinate

tau-fluvalinate furethrin imiprothrin metofluthrin permethrin biopermethrin transpermethrin phenothrin prallethrin profluthrin pyresmethrin resmethrin bioresmethrin cismethrin tefluthrin terallethrin tetramethrin tralomethrin transfluthrin etofenprox flufenprox halfenprox protrifenbute silafluofen

Pyrimidinamine Insecticides

flufenerim pyrimidifen

Pyrrole Insecticides

chlorfenapyr

Tetronic Acid Insecticides

spiromesifen

Thiourea Insecticides

diafenthiuron

Urea Insecticides

flucofuron

sulcofuron

Other Insecticides

closantel crotamiton EXD fenazaflor fenoxacrim hydramethylnon isoprothiolane malonoben metoxadiazone nifluridide pyridaben pyridalyl rafoxanide triarathene triazamate

Preferred bactericides include:

bronopol cresol dichlorophen dipyrithione

dodicin fenaminosulf formaldehyde hydrargaphen 8-hydroxyquinoline sulfate kasugamycin nitrapyrin

octhilinone oxolinic acid oxytetracycline probenazole

streptomycin tecloftalam thiomersal

The particles are dispersed in dispersants which include standard dispersants known in the art. The dispersant can be cationic, non-ionic and anionic, and the preferred dispersants are either non-ionic or cationic. Examples of surfactants which can be used in the compositions and methods of the present invention include acrylic copolymers, an aqueous solution of copolymers with pigment affinity groups, polycarboxylate ether, modified polyacrylate, acrylic polymer emulsions, modified acrylic polymers, poly carboxylic acid polymers and their salts, modified poly carboxylic acid polymers and their salts, fatty acid modified polyester, aliphatic polyether or modified aliphatic polyether, polyetherphosphate, modified maleic anhydride/styrene copolymer, lignin and the like.

For metal or metal compound biocides, the level of dispersant is in the range of from about 0.1 to 180% of the weight of the biocide compounds, with a preferred range of 1 to 80%, a more preferred range of 5 to 60%, and a most preferred range of 10 to 30%. For organic biocides, such as, for example, tebuconazole, cyproconazole, imidacloprid, chlorothalonil, etc, the level of dispersant is in the range of from about 1 to 200% of the weight of the biocide compounds, with a preferred range of 5 to 100%, a more preferred range of 10 to 80%, and a most preferred range of 30 to 70%.

If desired, a wetting agent can be used in the preparation of the compositions of the present invention. For metal or metal compound biocides, the level of wetting agent is in the range of from about 0.1 to 180% of the weight of the biocide compounds, with a preferred range of 1 to 80%, a more preferred range of 5 to 60%, and a most preferred range of 10 to 30%. For organic biocides, such as, for example, tebuconazole, cyproconazole, imidacloprid, chlorothalonil, etc, the level of wetting agent is in the range of from about 1 to 200% of the weight of the biocide compounds, with a preferred range of 5 to 100%, a more preferred range of 10 to 80%, and a most preferred range of 30 to 70%.

If desired, the composition can contain enhancing agents, such as trialkylamine oxides, alkoxylated diamines and the like, which improve the biocidal-efficacy of micronized copper formulations.

Preferred trialkylamine oxides have the following structure.

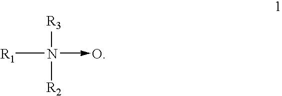

where R₁ is a linear or cyclic C₈ to C₄₀ saturated or unsaturated group and R₂ and R₃ independently are linear C₁ to C₄₀ saturated or unsaturated groups.

Preferred alkoxylated diamines have the following structure:

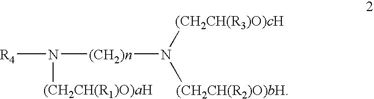

where n is an integer which can vary from 1 to 4, R₁, R₂ and R₃ are independently selected from the group consisting of hydrogen, methyl, ethyl and phenyl, and a, b and c are each integers which can be 1 to 6, and R₄ is fatty alkyl of C₈ to C₂₂. In one embodiment, micronized metal or metal copper compound is mixed with an insoluble micronized organic biocide. The metal or metal compound and the insoluble biocide may be micronized separately and then mixed or may be mixed first, followed by micronization.

Non-biocidal components such as water repellants (such as wax emulsions), colorants, emulsifying agents, dispersants, stabilizers, UV inhibitors, enhancing agents (such as trialkylamine oxides and alkoxylated diamines) and the like may also be added to the composition disclosed herein to further enhance the performance of the system or the appearance and performance of the resulting treated products. Those skilled in the art will recognize that some of these agents may also have some biocidal properties.

The compositions of the present invention can be a concentrate or a preparation which is ready to apply to wood. In general, the total biocide content of the concentrate is in the range of from 1 wt % to 80 wt %, based on weight of composition, and preferably in the range of from 5 to 70 wt %, and more preferably in the range of from 30 to 65 wt %.

It should be noted that, in the compositions of the present invention, it is not necessary to introduce ammonia, MEA or other amines during the preparation of the composition. Thus the compositions of the present invention are substantially free of amines. By “substantially amine-free” it is meant that the amine component is less than 5 wt % of the composition based upon the weight of the particulate metal/metal compound component. In other embodiments, the composition of the present invention has less than 4 wt %, 3 wt %, 2 wt % and 1 wt % amine respectively. In one embodiment, the compositions is completely free of amines.

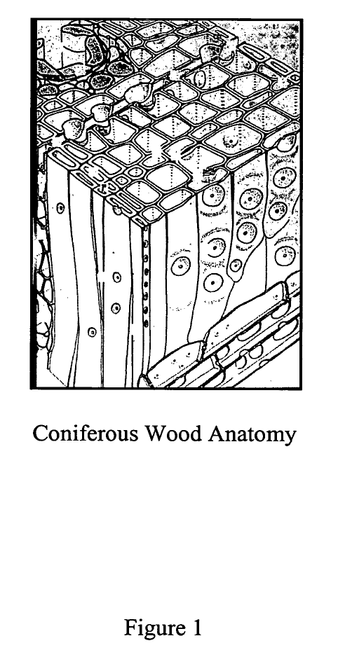

The degree of penetration and uniformity of distribution of the dispersion formulation into the wood cellular structure is related to the prevalence of particles with relatively large particle size. If the copper source used in formulating the dispersion formulation disclosed herein has a particle size in excess of 25 microns, the particles may be filtered by the surface of the wood and thus may not be uniformly distributed within the cell and cell wall. Furthermore, particles with long axes greater than 25 micron may clog tracheids and inhibit the uptake of additional particles. As shown in FIG. 1, the primary entry and movement of fluids through wood tissue occurs primarily through the tracheids and border pits. Tracheids have a diameter of about thirty microns. Fluids are transferred between wood cells by means of border pits.

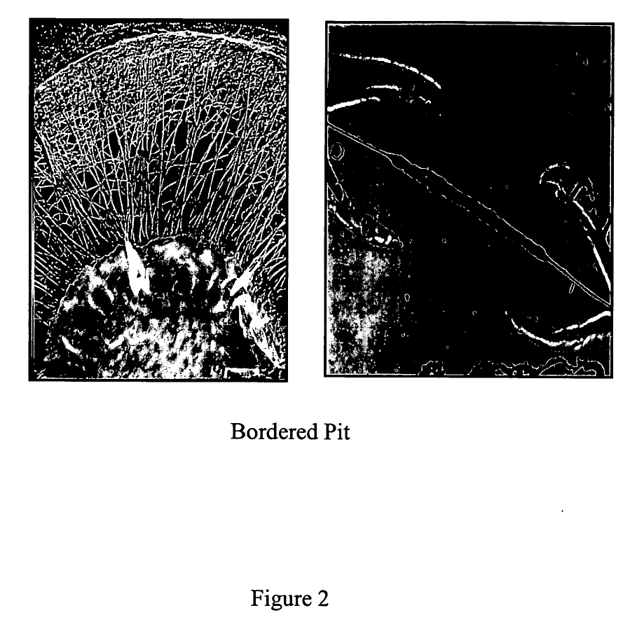

The overall diameter of the border pit chambers typically varies from a several microns up to thirty microns while, the diameter of the pit openings (via the microfibrils) typically varies from several hundredths of a micron to several microns. FIG. 2 depicts the border pit structure for coniferous woods.

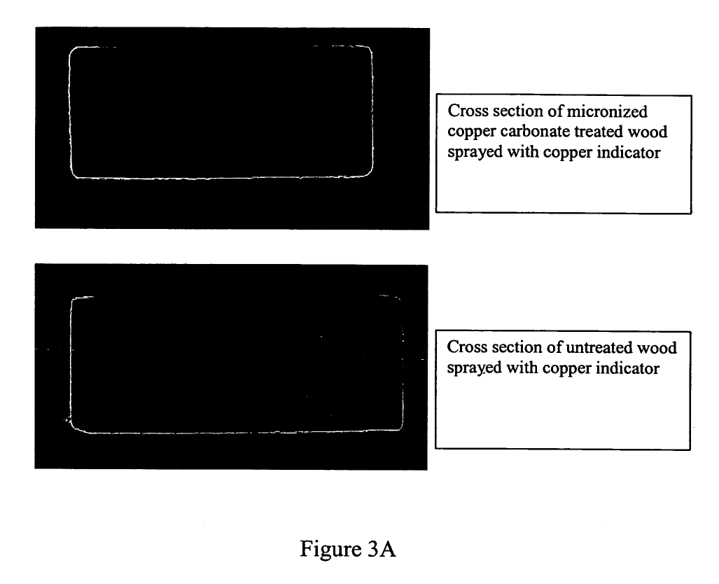

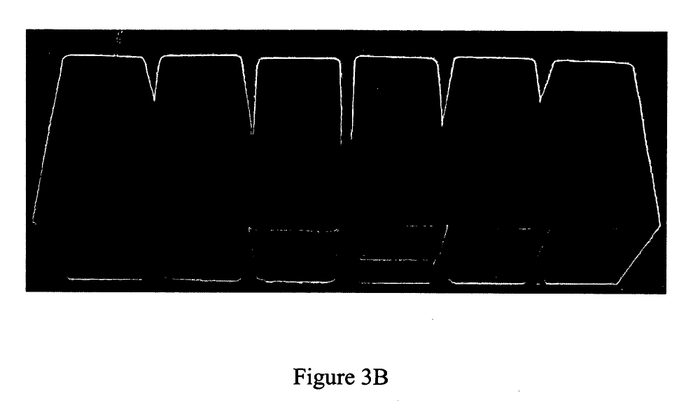

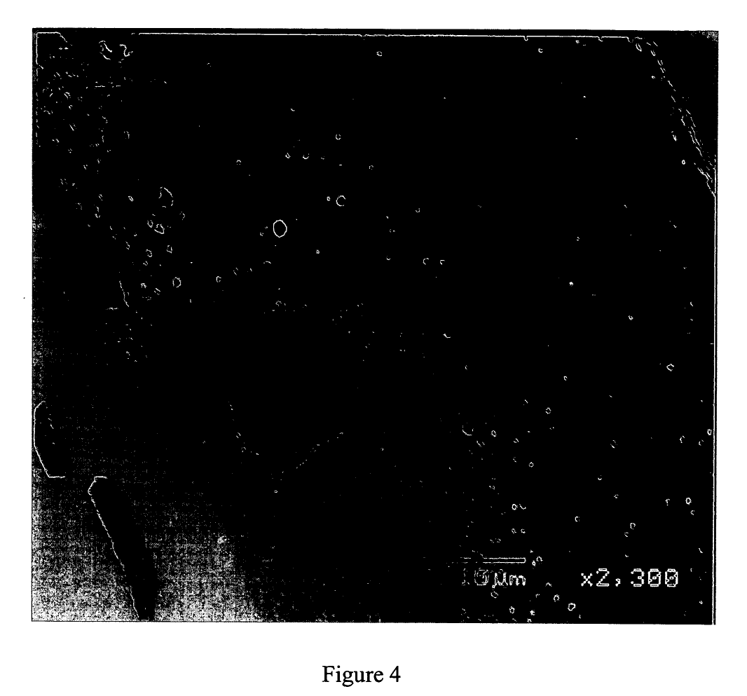

When wood is treated with micronized preservative formulation, if the particle size of the micronized preservative is less than the diameter of the pit openings, a complete penetration and a uniform distribution of micronized preservative in wood is expected. FIG. 3A depicts the complete copper penetration in wood treated with micronized copper hydroxide according to AWPA Standard A3-00 “Standard Method for Determining Penetration of Preservatives and Fire Retardants”. A uniform blue was observed indicating the presence of copper. FIG. 3B depicts the complete copper penetration in wood treated with micronized copper carbonate plus quat. Again, a uniform blue color was observed indicating the presence of copper. The determination of copper penetration was conducted following the procedures described in AWPA Standard A3-00 “Standard Method for Determining Penetration of Preservatives and Fire Retardants”. FIG. 4 depicts the uniform particle distribution of copper carbonate through the cells of the wood treated with micronized copper carbonate through the observation of Scanning Electron Microscope (SEM). The particles were confirmed to be copper compounds by the use of SEM-Energy Dispersed X-ray Analysis (EDXA).

It should be understood that although the compositions disclosed herein contain micronized particles, they can contain particles which are not micronized, i.e., with diameters which are outside the range of from 0.001 to 25 microns.

As with the inorganic component, if a particulate organic biocide is used, the organic biocide particle sizes should correspond to a distribution in which the largest particles do not appreciably inhibit the penetration of the particulate inorganic and organic components. If more than one micronized component is used, it is thus desirable that 98% (by weight) of the total number of particles in the composition have diameters which are less than 25 microns, and preferably less than 10 microns more preferably, less than 5 micron and more preferably, less than 1 micron.

Particle size distributions which conform to the above size distribution parameters can be prepared by methods known in the art. For example, particles can be obtained by grinding the mixture of copper compounds and dispersant. The particle size distribution can controlled by the ratio of dispersant to copper compounds, grinding times, the size of grinding media, etc. It is within the ability of one skilled in the art to adjust the aforementioned parameters in order to obtain a suitable distribution, such as a non-clogging particle distribution in which greater than about 3 weight percent of the particles have a diameter of 0.5 microns.

The present invention also provides a method for preservation of wood. In one embodiment, the method comprises the steps of treating wood with a composition (treating fluid) comprising a dispersion of water insoluble micronized metal and/or metal compounds. In another embodiment, wood is treated with a composition comprising a dispersion of micronized metal and/or metal compounds and organic biocides, wherein the organic biocides are soluble or present as water insoluble micronized particles.

The treating fluid may be applied to wood by dipping, soaking, spraying, brushing, or any other means well known in the art. In a preferred embodiment, vacuum and/or pressure techniques are used to impregnate the wood in accord with this invention including the standard processes, such as the “Empty Cell” process, the “Modified Full Cell” process and the “Full Cell” process, and any other vacuum and/or pressure processes which are well known to those skilled in the art.

The standard processes are defined as described in AWPA Standard C1-03 “All Timber Products—Preservative Treatment by Pressure Processes”. In the “Empty Cell” process, prior to the introduction of preservative, materials are subjected to atmospheric air pressure (Lowry) or to higher air pressures (Rueping) of the necessary intensity and duration. In the “Modified Full Cell”, prior to introduction of preservative, materials are subjected to a vacuum of less than 77 kPa (22 inch Hg) (sea level equivalent). A final vacuum of not less than 77 kPa (22 inch Hg) (sea level equivalent) shall be used. In the “Full Cell Process”, prior to introduction of preservative or during any period of condition prior to treatment, materials are subjected to a vacuum of not less than 77 kPa (22 inch Hg). A final vacuum of not less than 77 kPa (22 inch Hg) is used.

The following examples are provided to further describe certain embodiments of the invention but are in no way meant to limit the scope of the invention. Examples 1 through 5 demonstrate the formulation of the concentrated dispersions of copper compounds and the concentrated dispersions of copper compounds comprising various organic biocides. Examples 6 through 14 demonstrate the preparation of treating fluids using concentrated dispersions for the treatment of wood.

### EXAMPLE 1

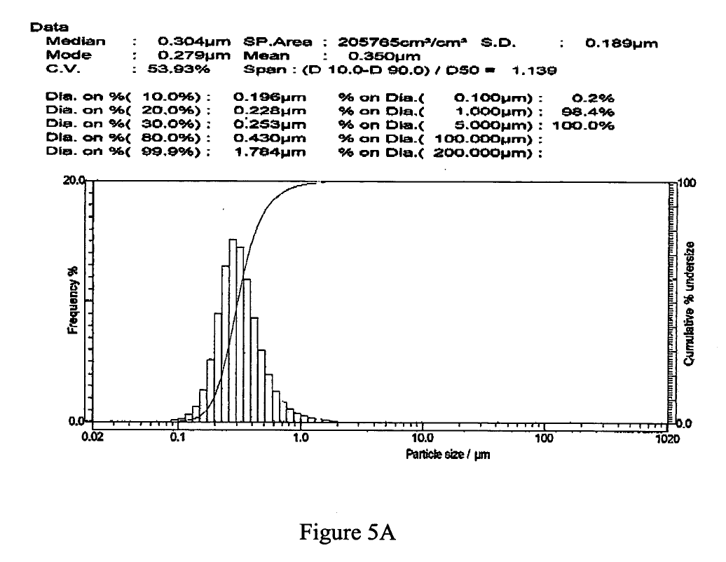

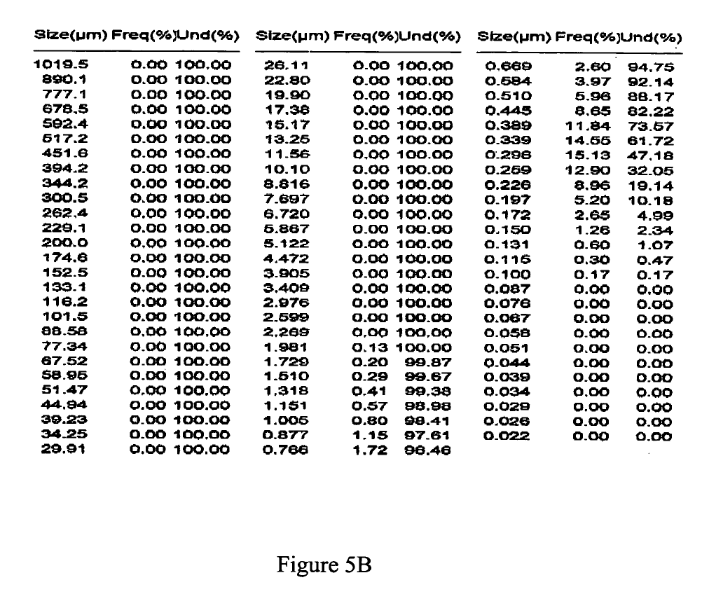

1000 g wetcake copper carbonate containing about 22% moisture were added to a container containing a mixture of 397.0 grams of water, 120.0 grams of a commercially available modified polyacrylate based dispersant and 3.0 g of a Si-based defoamer. The mixture was mechanically stirred for 5 minutes and then placed in a commercially available grinding media mill. The grinding media was a Zirconium based media with a size of 0.4 to 0.6 mm, ground at 2500 rpm agitation speed. The sample was ground for about 30 minutes, and a stable dispersion containing about 22.3% copper was obtained. The particle size of the copper carbonate dispersion was analyzed by Horiba LA-910 Particle Size Distribution Analyzer (PSDA). The mean particle size was 0.35 micrometers (um) with about 10% greater than 0.5 microns (as in FIG. 5).

### EXAMPLE 2

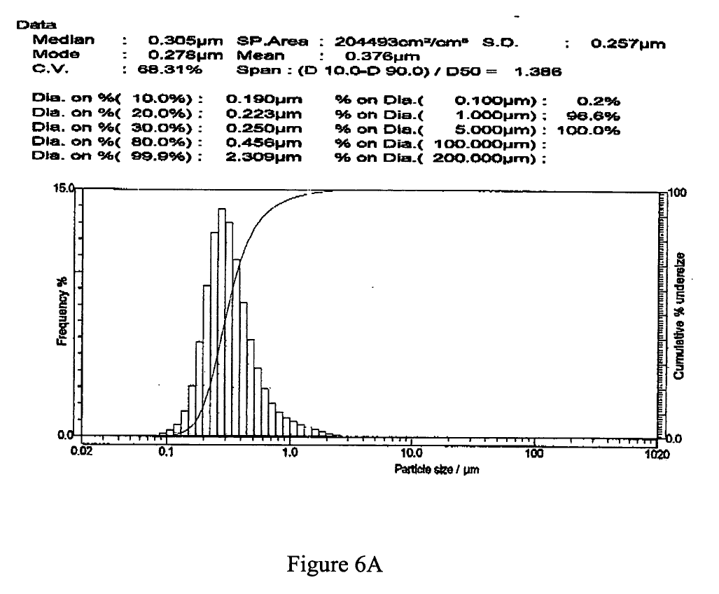

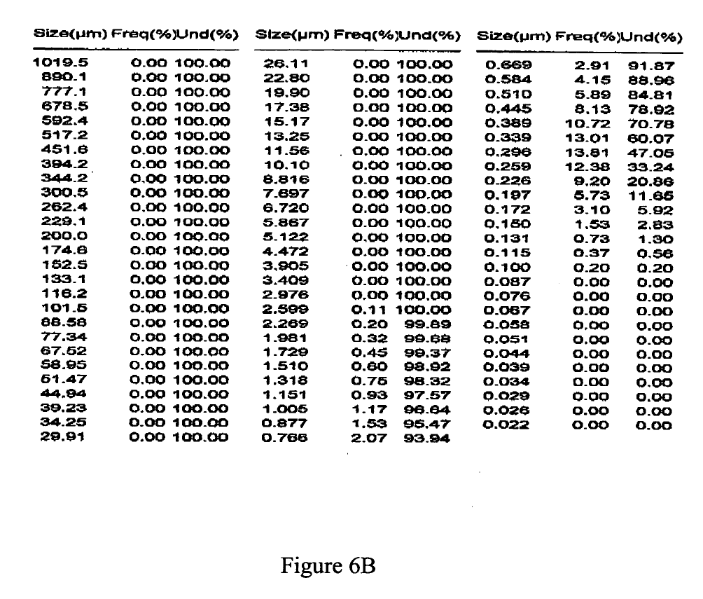

1000 g copper carbonate powder were added to a container containing a mixture of 417.0 grams of water, 150.0 grams of a commercially available modified polycarboxylate ether-based dispersant and 3.0 g Si-based defoamer. The mixture was mechanically stirred for 5 minutes and then placed in a commercially available grinding media mill. The grinding media was a Zirconium based media with a size of 0.2 to 0.3 mm, and ground at 2400 rpm agitation speed. The sample was ground for about 25 minutes, and a stable dispersion containing about 21.8% copper was obtained. The particle size of the copper carbonate dispersion was analyzed by Horiba LA-910 Particle Size Distribution Analyzer (PSDA). The mean particle size was 0.376 micrometers (um) with about 15% greater than 0.5 microns (as in FIG. 6).

### EXAMPLE 3

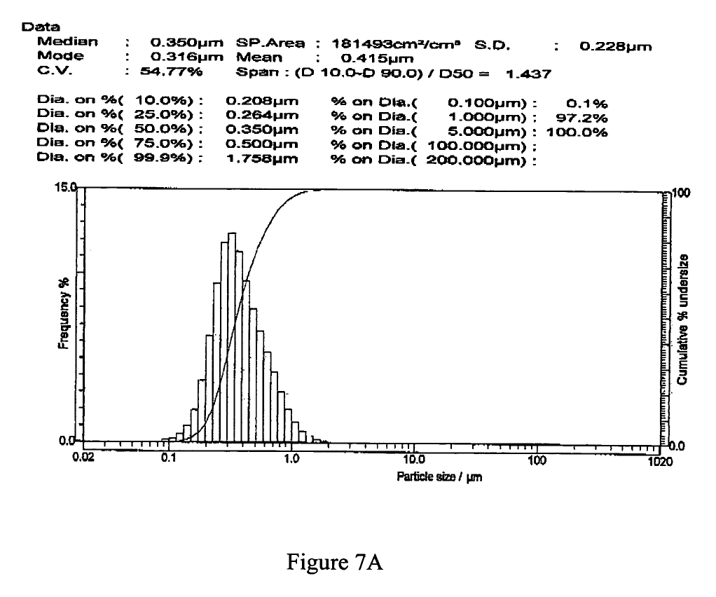

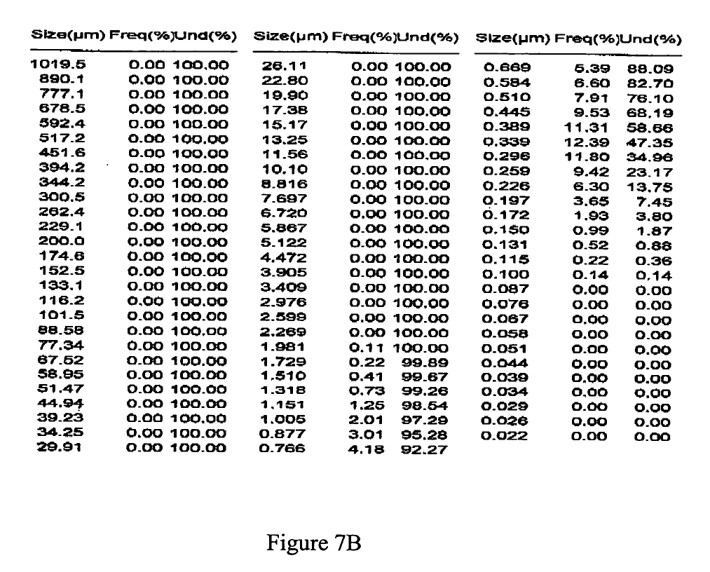

1000 grams of basic copper carbonate was mixed with 3780 grams of water and 200 grams of modified polycarboxylate ether dispersants. The mixture was mechanically stirred for about 10 minutes. The mixture was then placed in a commercially available grinding mill with grinding media having a size in the range of 0.4 to 0.6 mm and ground at 2600 rpm for about 30 minutes. A stable dispersion containing 25% basic copper carbonate was obtained. The particle size of the copper carbonate dispersion was analyzed by Horiba LA-910 Particle Size Distribution Analyzer (PSDA). The mean particle size was 0.415 micrometers (um) with about 25% greater than 0.5 microns (as in FIG. 7).

### EXAMPLE 4

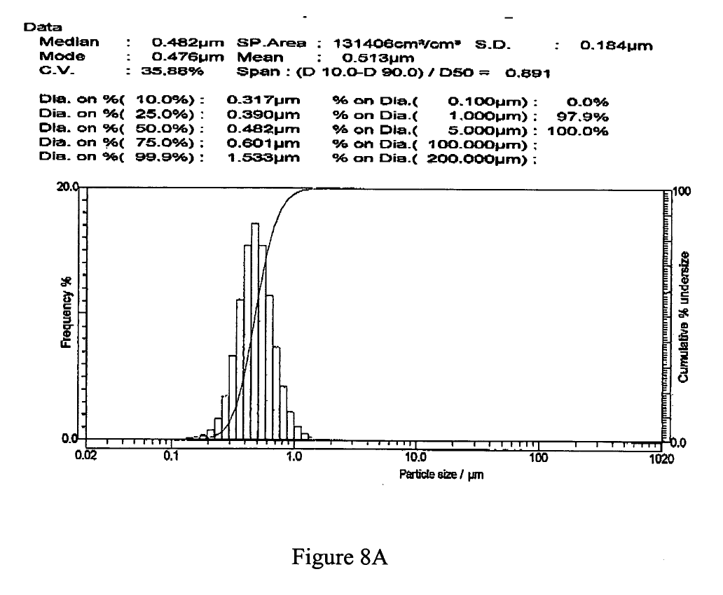

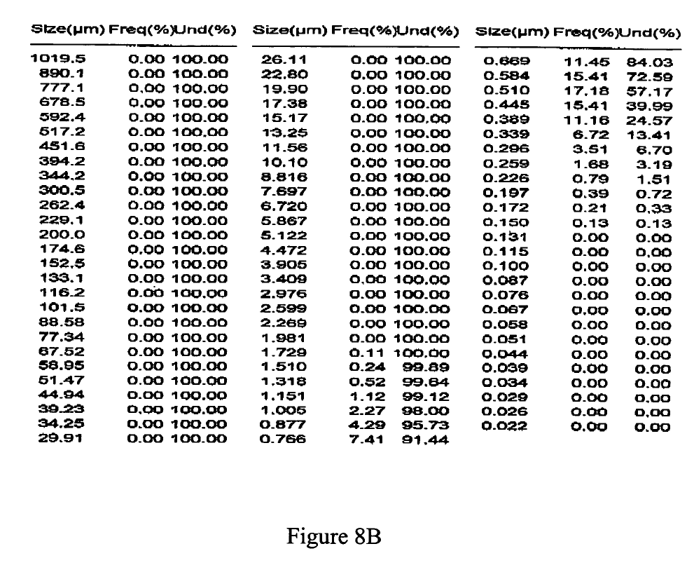

2000 grams of copper 8-hydroxyquinolate (Cu-8) were mixed with 2890 grams of water, 400 grams of a modified acrylic polymer based dispersant and 20 g of a Si-based defoamer. The mixture was mechanically mixed for about 5 minutes and placed in a commercially available grinding mill with grinding media having a size in the range of 0.2 to 0.3 mm and ground at 2650 rpm for about 140 minutes. A stable dispersion containing about 35% Cu-8 was obtained. The particle size of the copper carbonate dispersion was analyzed by Horiba LA-910 Particle Size Distribution Analyzer (PSDA). The mean particle size was 0.513 micrometers (um) with about 43% greater than 0.5 microns (as in FIG. 8).

### EXAMPLE 5

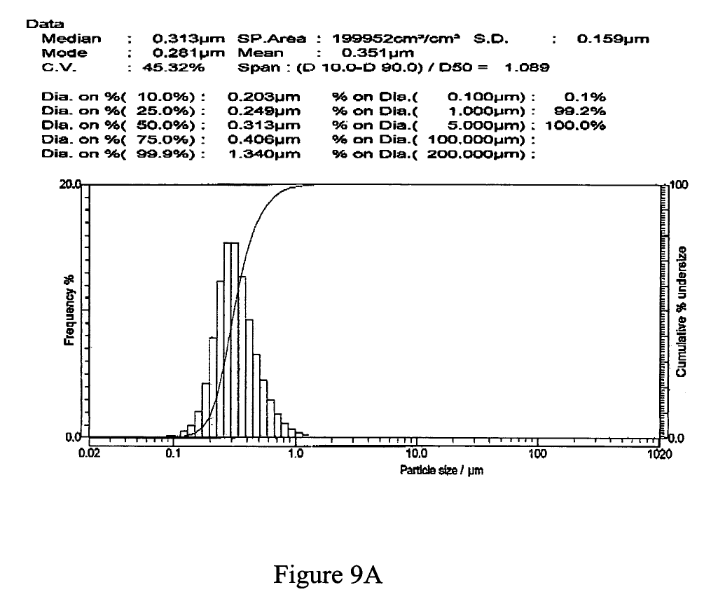

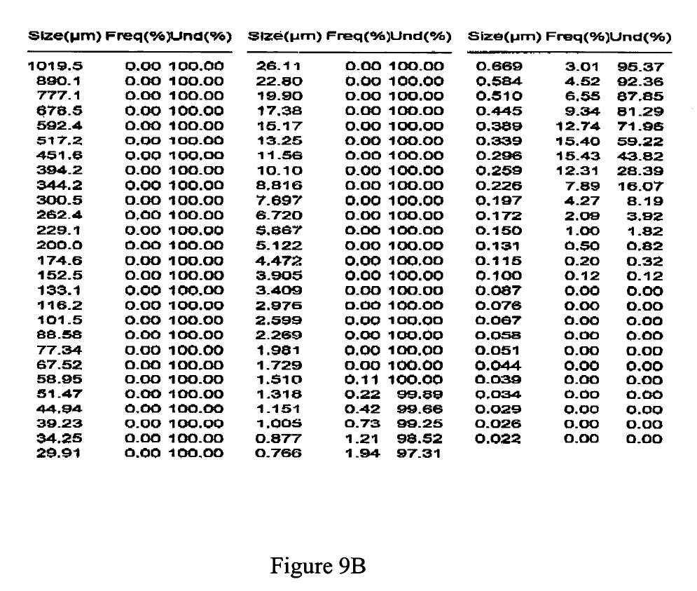

534.6 grams of copper 8-hydroxyquinolate (Cu-8) were mixed with 855.0 grams of water, 106.8 grams of modified polyacrylate based dispersants and 3.8 g of a silicon-based defoamer. The mixture was mechanically mixed for about 5 minutes and placed in a grinding mill with media having a size in the range of from 0.4 to 0.7 mm. The mixture was ground for about 140 minutes at 2400 rpm and a stable dispersion containing about 35% Cu-8 was obtained. The particle size of the copper carbonate dispersion was analyzed by Horiba LA-910 Particle Size Distribution Analyzer (PSDA). The mean particle size was 0.351 micrometers (um) with about 12% greater than 0.5 microns (as in FIG. 9).

### EXAMPLE 6

38.5 g of cupric carbonate dispersion from Example 1 (FIG. 5) was mixed with 7.5 g of N,N-dimethyl-1-dodecylamine-N-oxide (AO) and 2954.0 g of water to produce a preservative treating fluid. The fluid was then used to treat 2″×4″×10″ samples of southern pine sapwood, and sealed with epoxy resin, using an initial vacuum of 28″ Hg for 15 minutes, followed by a pressure cycle of 135 psi for 25 minutes and a final vacuum of 27″ Hg for 10 minutes. The resulting treated wood was weighed and found to have doubled its weight. The treated sample was cut and the cross sections sprayed with a copper indicator to determine copper penetration following the procedure described in American Wood Preservers' Association Standard A3-00, and the blue color indicates the presence of copper. The sample was found to have 100% uniform distribution of copper throughout the cross section as in FIG. 4A. As a comparison, FIG. 4A also showed the cross section of untreated wood.

### EXAMPLE 7

50.0 g copper carbonate dispersion from Example 2 (FIG. 6) were mixed with 2942.5 g of water and 7.5 g of didecyldimethylammonium chloride. The product was mixed until uniformly dispersed. A southern pine stake measuring 1.5″×3.5″×10″ was placed in a laboratory retort with a vacuum of 27″ Hg for 15 minutes. The treating composition was then pumped into the retort and the retort pressurized to 130 psi for 30 minutes. The composition was drained from the retort and the test stake weighed. Based on the weight pickup, the test stake doubled its weight and showed uniform penetration of the cupric oxide throughout the wood cross section.

### EXAMPLE 8

4000 g of treating fluid containing 0.50% of cupric oxide and 0.25% didecyldimethylammonium carbonate were prepared by mixing copper carbonate dispersion from Example 3 (FIG. 7) and didecyldimethylammonium carbonate. The fluid was used to treat 2″×4″×10″ southern pine samples by placing the samples in a chamber and drawing a 27″ Hg vacuum for 10 minutes. The treating fluid was then drawn into the chamber and allowed to stay in contact with the wood cubes for 15 minutes. The fluid was pumped from the chamber and the resulting wood had more than doubled its weight. Cross sections of the cubes showed 100% copper penetration according to AWPA A3-00.

### EXAMPLE 9

A preservative treating formulation was prepared by adding 0.15 kg of copper carbonate dispersion from (FIG. 6) to 0.025 kg of N,N-dimethyl-1-hexadecylamine-N-oxide and 4.825 kg of water. This fluid was allowed to mix until a homogenous fluid was prepared. This fluid was used to treat southern pine test stakes measuring 0.156×1.5×10.0 inchs (4×38×254 mm) by the full-cell process. The resulting stakes showed a uniform distribution of copper throughout the wood cells. The treated test stakes were installed in the field to evaluate the field performance of the preservative following the procedure described in AWPA Standard E7-01 “Standard Method of Evaluating Wood Preservatives by Field Tests with Stakes”. The test results indicated that the treated stakes were resistant to decay and insect attack. The fluid was also used to treat southern pine wood cube blocks measuring ¾″×¾″×¾″ (19 mm×19 mm×19 mm). The treated cubes were exposed to several test fungi to evaluate the bio-efficacy of the preservative formulation following the procedure described in AWPA Standard E10-01 “Standard Method of Testing Wood Preservatives by Laboratory Soil-Block Cultures”. Upon the completion of the soil-block test, the cubes were found to have less than 2.0% weight loss, indicating essentially no fungal attack to the treated cubes. In comparison, untreated wood cubes had approximately 50% weight loss after being exposed to the test fungi. The soil block test results indicated wood treated the above preservative formulation was resistant to fungal attack.

### EXAMPLE 10

A preservative treating composition was prepared by adding 0.1 kg of dispersion from Example 2 (FIG. 6) to 4.9 kg of water. The resulting fluid was mixed a tebuconazole formulation to give a final composition containing 0.50% copper carbonate and 0.01% tebuconazole. This fluid was then used to treat full-size lumber using the full-cell process wherein the wood is initially placed under a vacuum of 30″ Hg for 30 minutes, followed by the addition of the treating composition. The system was then pressurized for 30 minutes at 110 psi. A final vacuum of 28″ Hg for 30 minutes was applied to the wood to remove residual liquid. The wood was found to contain a uniform distribution of copper (by AWPA A3-00) throughout the cross sections and is resistant to fungal and insect attack as determined by soil block and field testing.

### EXAMPLE 11

54 g of dispersion from Example 1 (FIG. 5) and 7.5 g of N,N-dimethyl-1-hexadecylamine-N-oxide (AO) were mixed with 2938.5 grams of water to obtain a preservative treating fluid. The resulting fluid was used to treat red pine lumber using a modified full-cell process. The resulting stakes were air-dried and found to contain a uniform distribution of copper (by AWPA A3-00) throughout the cross sections and is resistant to fungal and insect attack as determined by soil block and field testing.

### EXAMPLE 12

A preservative treating fluid was prepared by adding 16.0 g of Cu 8-hydroxyquinolate (Cu-8) dispersion from Example 4 (FIG. 8) to 3984.0 g of water. The resulting fluid contained 0.1% Cu-8. The fluid was used to treat southern pine lumber using a full cell process. The resulting stakes were air-dried and found to contain a uniform distribution of copper (by AWPA A3-00) throughout the cross sections and is resistant to fungal and insect attack as determined by soil block and field testing.

### EXAMPLE 13

A preservative treating fluid was prepared by mixing Cu-8 dispersion from Example 5 (FIG. 9) with water to give a 0.15% Cu-8 treating fluid. The resulting fluid was used to treat lumber using a full cell process. The treated wood was air-dried and was found to be resistant to fungal and insect attack as determined by soil block and field testing.

Although specific embodiments have been described herein, those skilled in the art will recognize that routine modifications can be made without departing from the spirit of the invention.

We claim:

1) A method for treating wood comprising the steps of:
a) providing a mixture comprising a dispersion of micronized biocide particles in a carrier such that at least 98% by weight of the particles have a diameter less than 10 microns and at least 3% by weight of the particles have a diameter of 0.5 microns or greater; and
b) applying the dispersion to a wood or wood product, such that some or all of the particles penetrate the surface of the wood.

2) A method as in claim 1 wherein the wood is a coniferous wood.

3) A method as in claim 1 wherein the wood or wood product comprises a wood selected from the types in the group consisting of southern pine, red pine, ponderosa pine, patula pine, Brazilian pine, Caribbean pine, and Radiata pine.

4) A method as in claim 1 wherein the biocide in step a comprises copper or a copper compound.

5) A method as in claim 1 wherein the biocide in step a comprises cuprous oxide, cupric oxide, basic copper carbonate, copper carbonate, copper hydroxide, copper 8-hydroxyquinolate (oxine copper), copper borate and copper omadine.

6) A method as in claim 1 wherein the biocide in step a comprises an organic biocide.

7) A method as in claim 6 wherein the organic biocide is tebuconazole, cyproconazole, chlorothalonil, imidacloprid, bifenthrin, dichlorooctoisothiazolinone (DCOIT), permethrin, cypermethrin, and fipronil.

8) A method as in claim 1 wherein in the range of 3 to 50% by weight of the particles have a diameter of 0.5 microns or greater.

9) A method as in claim 4 wherein in the range of 3 to 50% by weight of the particles have a diameter of 0.5 microns or greater.

10) A method as in claim 1 wherein in the range of 3 to 25% by weight of the particles have a diameter of 0.5 microns or greater.

11) A method as in claim 1 wherein the mixture in step a further comprises a dispersant.

12) A method as in claim 11 wherein the dispersant is selected from the types in the group consisting of acrylic copolymers, an aqueous solution of copolymers with pigment affinity groups, polycarboxylate ether, modified polyacrylate, acrylic polymer emulsions, modified acrylic polymers, poly carboxylic acid polymers and their salts, modified poly carboxylic acid polymers and their salts, fatty acid modified polyester, aliphatic polyether or modified aliphatic polyether, polyetherphosphate, modified maleic anhydride/styrene copolymer, and lignin.

13) A method as in claim 1 wherein the mixture further comprises a non-biocidal component selected from the types in the group consisting of water repellants, colorants, emulsifying agents, dispersants, stabilizers, UV inhibitors, and wood dimensional stabilizers.

14) A method as in claim 1 wherein the carrier is organic.

15) A method as in claim 1 wherein at least 1 weight percent of the particles penetrate at least 1 mm into the wood.

16) A wood preservative composition comprising a mixture comprising a dispersion of micronized biocide particles in a carrier such that at least 98% by weight of the particles have a diameter less than 10 microns and at least 3% by weight of the particles have a diameter of 0.5 microns or greater.

17) A composition as in claim 16 wherein the biocide comprises cuprous oxide, cupric oxide, basic copper carbonate, copper carbonate, copper hydroxide, copper 8-hydroxyquinolate (oxine copper), copper borate and copper omadine.

18) A composition as in claim 16 wherein the organic biocide is tebuconazole, cyproconazole, chlorothalonil, imidacloprid, bifenthrin, dichlorooctoisothiazolinone (DCOIT), permethrin, cypermethrin, and fipronil.

19) A composition as in claim 16 wherein in the range of 3 to 50% by weight of the particles have a diameter of 0.5 microns or greater.

20) A composition as in claim 16 wherein in the range of 3 to 25% by weight of the particles have a diameter of 0.5 microns or greater.

21) Wood or wood product having distributed through at least a portion thereof a composition comprising a particulate biocide wherein at least 98% by weight of the particles have a diameter less than 10 microns and at least 3% by weight of the particles have a diameter of 0.5 microns or greater.

22) Wood or wood product as in claim 21 wherein the wood is a coniferous wood.

23) Wood or wood product as in claim 21 wherein the particulate biocide comprises copper or a copper compound.
